(19) United States
(12) Patent Application Publication
(10) Pub. No.: US 2014/0332355 A1
(43) Pub. Date: Nov. 13, 2014

(54) Childproof electric switch enclosure

(71) Applicants: Philip Onni Jarvinen, Amherst, NH (US); Kathleen Mary Jarvinen, West Roxbury, MA (US)

(72) Inventors: Philip Onni Jarvinen, Amherst, NH (US); Kathleen Mary Jarvinen, West Roxbury, MA (US)

(73) Assignee: Philip Jarvinen

(21) Appl. No.: 13/815,956

(22) Filed: May 7, 2013

(51) Int. Cl. H01H 9/02

(52) U.S. Cl. CPC H01H 9/02
USPC 200/43.01

(57) ABSTRACT

The present invention is a childproof electrical switch cover that prevents children from operating the enclosed toggle or rocker electrical switch but allows adults to do so. The childproof cover is placed over the existing electrical switch to be protected and is held firmly in place against the existing electrical switch using the same hardware previously used to hold the existing electrical switch firmly against its support structure: the childproof electric switch cover and the wall switch that it is placed upon forming a protected volume that is not accessible to children attempting to actuate the electrical switch. Access by adults to the existing switch is provided thru removable childproof caps located on the childproof cover. When the childproof cap of the present invention is removed by an adult, the cover remains childproof. Additional childproofing is achieved by restricting the dimensions of the opening that is revealed when the cap is removed to those smaller then the width of a child's hand and by making the vertical height from the opening to the existing switch longer than a child's finger so the child can not reach the actuator of the switch.

### COPYRIGHT NOTICE

A portion of the disclosure of this patent document contains material that is subject to copyright protection. The copyright owner has no objection to the facsimile reproduction of the patent document or the patent disclosure, as it appears in the Patent and Trademark Office patent file or records, but otherwise reserves all copyright rights whatsoever.

### FIELD OF THE INVENTION

The invention relates to the field of electrical switch enclosures. In particular it relates to a permanent childproof cover, placed over an electrical switch and forming a complete enclosure, which denies access to the switch by children and prevents its operation by them, while allowing continued use by adults. The cover is held firmly in place by the existing switch plate fasteners. Access by toddlers and young children to the toggles or rockers elements which operate the switch inside the enclosure is completely denied while adults gain access through a portion of the enclosure that contains a childproof removable cap or caps. When the childproof cap is removed by an adult, the cover remains childproof through additional childproof features including an opening thru which a child's hand will not pass and with the opening also placed at a height above the toggle or rocker elements that allows adult fingers to manipulate the toggle or rocker elements but does not allow the shorter fingers of a child to reach these elements.

### BACKGROUND OF INVENTION

There are a number of situations that arise when it is necessary to deny access to and prevent the operation of electrical wall switches by toddlers and young children: toddlers and young children henceforth referred to as children. Examples of such situations include the need of parents to regain control over light switches in a child's room where the child insists on turning the lights back on to stay awake after the parents have put the child to bed for the night. Other situations include the need to assure the safety of the child in the home by preventing operation of a wall switch by them where, if allowed to occur, mechanical devices would be activated such as a garbage disposal unit or a bladed fan into which the child might place their hand and the need to avoid impairment of home safety that would be compromised, if at night and unknown to the occupants, the child had previously actuated a switch that had shut off outside protective lighting or the home alarm system.

Children learn how to operate electric wall switches by visually observing the action of parents and/or adults when the older people operate these devices. To prevent children from learning in such a manner, it is necessary that the visual attraction of the children to such devices be eliminated and that operation of such devices, when they occur by adults, be hidden from the child's view. The present invention is a childproof enclosure that is mounted over the wall switch that hides the existence of and operation of the switch from the child while also preventing the child from operating the toggle or rocker switch elements of the electrical switch. A childproof device is defined herein and in The Dictionary.com as a device designed to prevent the opening of, the tampering with, or the operation of any device by a child. The present invention is the first approach designed to accomplish those objectives and to be truly childproof.

It is therefore an objective of the present invention to house the wall switch in a strong, completely enclosing, non-penetrable to children, switch enclosure formed between the existing wall switch plate and the added cover.

It is a further objective of the present invention that the non-penetrable enclosure be mounted in a physically strong manner so that the enclosing cover may not be torn off by the actions of children.

It is a further objective of the present invention that the enclosure be constructed from opaque materials to visually hide the existence of the wall switch from the child and to completely remove any attraction of the child to it .

It is a further objective of the present invention that the enclosure be constructed from opaque materials so that when it is operated by adults, the enclosure completely prevents the child from observing how the wall switch is operated inside the enclosure by an adult so the child can not learn to do it themselves.

It is a further objective of the present invention that a portion of the enclosure be constructed with a removable childproof cap or caps so that adults may operate the enclosed toggles or rocker switches but children can not.

It is a further objective of the present invention to maintain the childproof feature of the enclosure such that upon removable of the childproof cap by an adult, the exposed opening be smaller than a child hand to exclude a child's hand from the interior of the envelope thus preventing operation of the wall switch by the child.

It is a further objective of the present invention to maintain the childproof function of the enclosure such that upon removable of the childproof cap by an adult that the opening of the enclosure be positioned at a height above the toggle or rocker switches so that only adult fingers entered into the enclosure may operate the switches and that a child's fingers can not.

The features and advantages described herein are not all inclusive and, in particular, many additional features will be apparent to one of ordinary skill in the art in view of the drawings, specifications and claims. Moreover, it should be noted that the language used in the specifications has been principally selected for readability and instructional purposes, and not to limit the scope of the inventive subject matter.

A search of prior art reveals no prior art which provides a completely protective childproof wall switch enclosure as implemented by the present invention.

### SUMMARY OF THE INVENTION

The present invention is defined by the claims, and nothing in this section should be read as a limitation on those claims. Rather by way of general introduction and briefly stated, various preferred embodiments are described that relate to a childproof electric switch cover that allows switch control elements to be operated by adults while preventing children from gaining access to and operating the toggle or rocker elements of the electrical switch protected by the cover.

Protection of an electrical switch from operation by the action of children in the prior art falls generally into two approaches: protection of switch operation by a switch guard or protection of switch operation by the addition of an enclosure. However, no completely childproof enclosure presently exists. The preferred embodiment of the present invention is a cover that is placed over a wall switch which forms a complete childproof enclosure with a portion of the enclosure being a childproof cap or caps that when removed by an adult allows the adult to operate the toggles or rocker switch elements but does not allow children to operate them. When the childproof cap is removed by an adult in the present invention, the opening that is revealed is itself childproof. In the preferred embodiment, this is accomplished by restricting the size of the opening so a child's hand can not pass through it and by making the distance from the opening to the toggle or rocker switch plate elements sufficiently long that adult fingers are required to operate them but the distance is in excess of the length of a child's finger so children can not operate them.

In the prior art, a switch guard is seen to be a mechanical arrangement that interferes with a direct frontal approach to the electrical switch by a child's hand or finger while an enclosure attempts to prevent operation of a switch in any manner by a child. All prior art switch guards leave open areas, gaps or passages on the sides, tops and/or bottoms of the switch thru which the switch may still be actuated by prying children fingers or, for example, by elongated instruments held in the child's hand. Thus, there are no switch guards that meet the childproof definition. Prior art switch enclosures that have been divulged, such as U. S. Patent Application U.S. 2011/0198200 titled “Childproof Light Switch Guard” do not provide an impenetrable enclosure and thus are not childproof. In particular, the so called childproof U.S. 2011/0198200 can be defeated, for instance, by a child holding a pencil, pen or crayon in its hand and inserting the instrument through the openings in such guard and against the toggle or rocker element, thus operating the switch.

The preferred embodiment of the present invention is a childproof switch enclosure in the form of a mechanical envelope which completely encloses a switch with the non-penetrable enclosure designed to prevent any and all tampering with or the opening of the enclosure by children in efforts to gain access to the toggles or rocker elements of the switch while still maintaining operation by an adult. The preferred embodiment of the present invention also is fastened to the switch box and thus to the wall in a manner that assures that the childproof cover may not be yanked from the wall by the actions of children. No prior art wall switch guard or wall switch enclosure has been found which is considered childproof as is the present invention.

In the preferred embodiment of the present invention, childproof access to the interior of the enclosure and to the toggles and rocker switch elements that operate the wall switch is denied by the addition of the childproof electric switch cover over the wall switch. To allow adults to operate the wall switch, a portion of the cover is equipped with a removable childproof cap or caps. The childproof cap can not be opened by a child but can only be opened by an adult who can then change the wall switch setting: on or off. Even with the childproof cap opened and removed by an adult, the childproof design of the present invention is preserved in the preferred embodiment by additional features. These additional features include restricting the physical dimensions of the opened passage to dimensions smaller than a child's hand while also making the distance from the opening to the toggles and rocker elements longer than a child's finger so that a child may not reach them or operate them.

A majority of childproof caps in the prior art, used to protect the contents of prescription pill vials and dangerous chemicals in containers from child access, are designed to be opened in either of two ways: either requiring the cap to be pressed axially down against the bottom portion of the vial or container while simultaneously applying a twist to the cap or by equipping the vial or container with a flexible cap that when squeezed laterally elongates into an elliptical shape thus releasing the cap from restrictive cogs on the bottom portion of the vial or container and allowing the cap to be twisted off the vial or container. These two techniques have been employed with minor variations from the beginning of childproof cap designs. The combined downward pressure and turn approach to open a childproof cap, labeled a Type 1 childproof cap in this application, was divulged in an early patent and perhaps even earlier. The early example being referred to is U.S. Pat. No. 3,853,236 issued Dec. 10, 1974 to Efrem M. Ostrowsky and titled “Safety Closure Unit”. An early example of the combined lateral pressure and turn approach to open a childproof cap, labeled a Type 2 childproof cap in this application, was divulged in U.S. Pat. No. 3,958,708 issued May 26, 1976 to Michael A. Le Bron, Jr. and titled “Oversize Safety Cap”. In that patent, lateral pressure against the outside flexible cap causes the round cap to become elongated in shape and engage inner and outer elements of the cap which in turn engages threads allowing the cap assembly to be removed.

Subsequent patents issued for Type 1 and Type 2 removable caps have varied the geometrical designs of the inner and outer cap elements or eliminated the inner cap element by clever design. However the two types of removable caps are still removable in the same manner: either with downward pressure and simultaneous twist or lateral pressure deforming the cap and simultaneous twist. The present invention uses for its childproof cap one of those divulged in an earlier patent whose patent protection no longer exists.

### BRIEF DESCRIPTION OF THE DRAWINGS

FIG. 1 is a drawing of a prior art switch guard in the form of a semicircular strap placed over the toggle of an electrical wall switch showing plan and side views.

FIG. 2 is a plan view drawing of the prior art switch guard divulged in U.S. Patent Application U.S. 2011/0198200.

FIG. 3 presents a plan view drawing of the device divulged in U.S. Patent Application U.S. 2011/0198200 with an added illustration which shows how the claimed childproof features are defeated by a child holding an elongated pencil, pen, crayon or stick in their hand.

FIG. 4 presents plan view and side view drawings of the present invention which illustrate the childproof cover mounted over a single toggle wall switch and forming a completely childproof enclosure.

FIG. 5 presents side view and end view drawings that illustrate how a prior art Type 1 childproof cap is removed by the simultaneous application of axial pressure and twisting motion applied to the cap.

FIG. 6 presents side view and end view drawings illustrating how a prior art Type 2 childproof cap is removed by the simultaneous application of lateral squeezing and twisting motion applied to the cap.

FIG. 7 presents a plan view of a prior art dual toggle element electrical switch.

FIG. 8 presents front view and side view drawings of the preferred embodiment of the present invention applied to dual toggle or rocker element switches.

FIG. 9 presents side view and plan view drawings of the present invention for a childproof cover for a dual toggle or dual rocker switch which employs a single, large diameter flat removable cap.

FIG. 10 presents a side view drawing of the present invention for a childproof cover for dual toggle or dual rocker switches employing a large diameter domed shaped removable cap.

### DETAILED DESCRIPTION

In prior art, a number of different approaches have been divulged for preventing children from operating electric wall switches but none of the previous designs have been truly childproof. Two examples of prior art are now considered to establish that the prior art was not childproof.

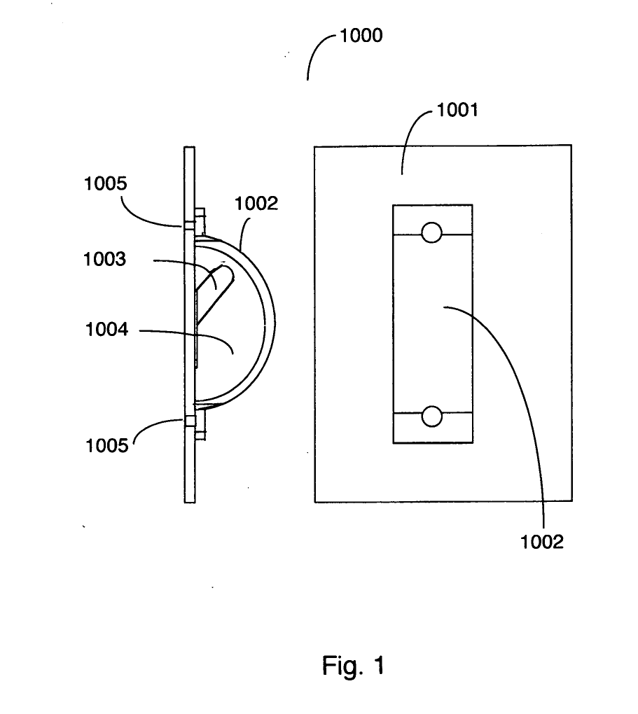

In the first example of prior art, a switch guard, of semi-circular shape and strap form, placed above and around the toggle of an electrical switch is presented in FIG. 1, 1000, with a side view of the switch guard shown on the left of FIG. 1 and a plan view shown on the right of FIG. 1. The existing switch plate, 1001, and the toggle switch element, 1003, to be protected from operation by a child, are noted. The strap hanger shaped switch guard is marked 1002. The switch guard is held in place against the switch plate 1001 with machine screws (not shown) placed through openings 1005 in the switch guard and thence thru the switch plate 1001 and thence into the switch box (not shown). As can be seen in the side view, an open area 1004 exists on the side of the switch guard, between the switch guard and the switch plate. This opening provides unwanted and undesired access to the toggle switch element by a child's fingers or by any elongated instrument, such as a pencil, pen, crayon or stick, held in a child's hand. Because of this side opening, the illustrated strap guard can not be considered childproof.

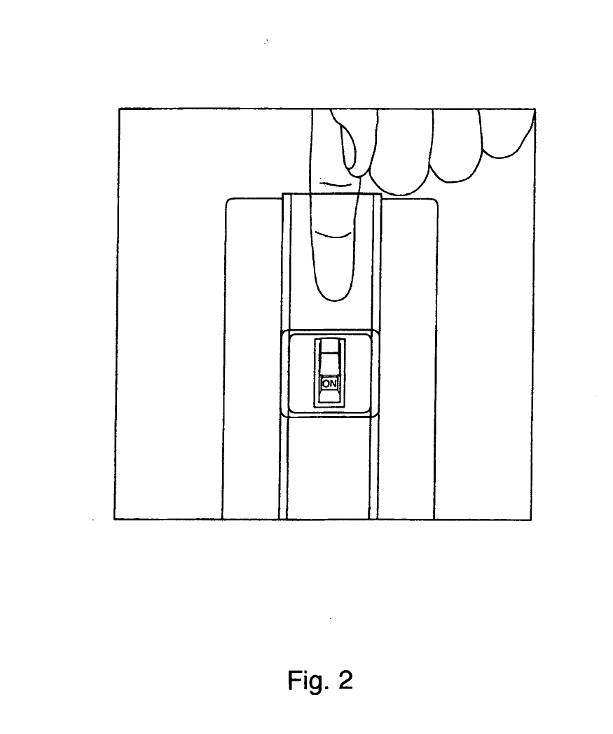

A second example of prior art for a wall switch guard is illustrated in FIG. 2, 2000, which is replicated from U.S. Patent Application U.S. 2011/0198200 titled “Childproof Light Switch Guard”. A product with the features described in that application and formed in transparent plastic is presently sold on Amazon.com and at other internet locations as the Levity Tree switch guard, Manufacture Part Number #01729, and titled the “Child Proof Light Switch Guard: Baby”

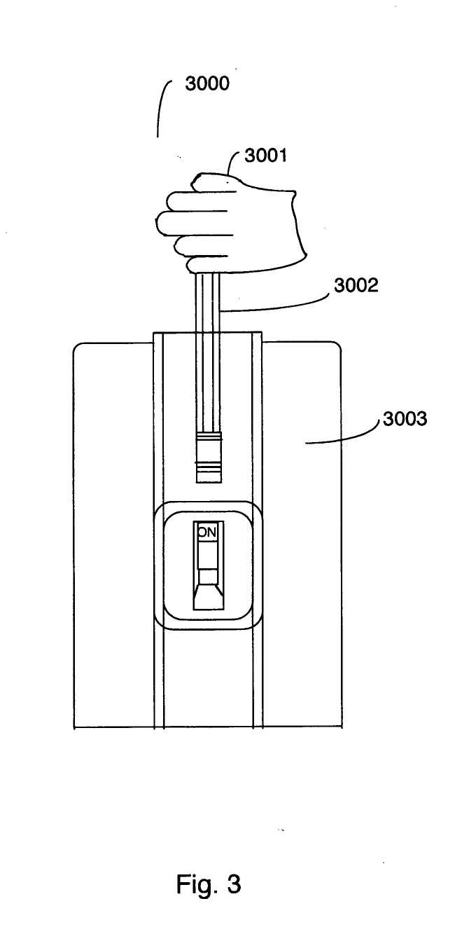

Application U.S. 2011/0198200 claims to provide a method for restricting small children from accessing a standard household wall switch. It employs an open, transparent, restricted size, tube of rectangular cross section which allows, as shown in FIG. 2, 2000, fingers of adult length to reach the toggle switch from above and below but not shorter fingers of children. Though the word childproof is claimed in the title of U.S. Patent Application U.S. 2011/0198200 and used to describe that application, the application can not be considered childproof since, as illustrated in FIG. 3, 3000, any child employing a slender instrument 3002, such as a pencil, pen, crayon or stick held in the child's hand 3001, can insert such an instrument into the rectangular channel from above or below and defeat the childproof feature described in U.S. 2011/0198200 by actuating the toggle switch.

U.S. Patent Application U.S. 2011/0198200 displays additional deficiencies in comparison with the present invention in that it is fabricated from transparent plastic material: use of transparent material in its construction allowing the toggle or rocker switch elements of the existing electrical switch to remain visually attractive to the child with the transparent plastic materials forming the body of the switch guard also allowing the child to visually observe operation of the switch elements by adults and thus learn to operate the toggle or switch elements themselves. The prior art “Childproof Light Switch Guard” is also deficient in mounting strength compared to the present invention for it is held in place using adhesive pads between its backside and the existing switch plate; the adhesive pads providing insufficient strength to defeat a child intent on tearing the device from the underlying switch plate. The present invention provides superior strength since it is attached directly to the underlying switch box with metal fasteners: the switch box in turn attached directly to the timbers forming the wall.

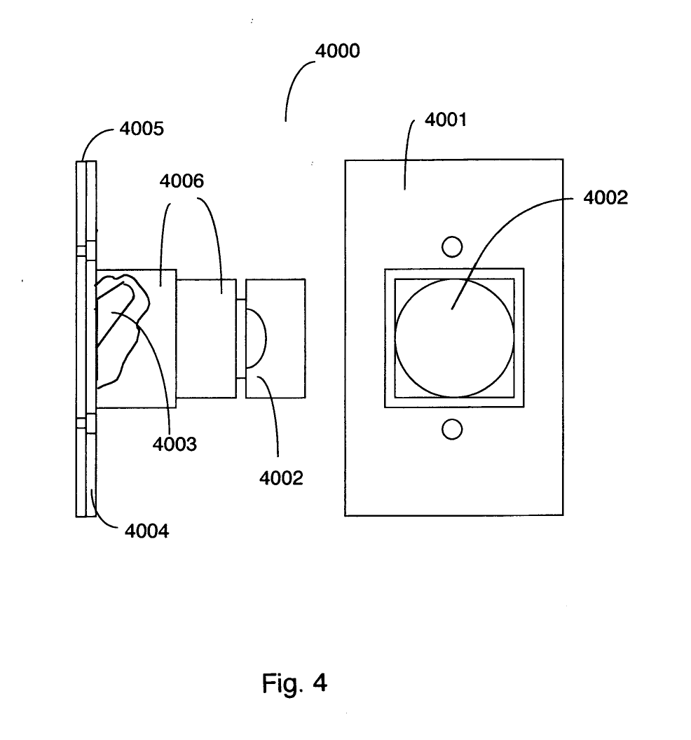

Plan view and side view drawings of the present invention provided in FIG. 4, 4000, illustrate the childproof cover, 4002 plus 4006 mounted over a single toggle electric wall switch, 4003, and forming a completely childproof enclosure. In FIG. 4, a childproof cap made part of the childproof electric switch enclosure provides a device that does not allow children to operate the toggle switch, 4003, but still allows adults to do so. The fixed potion of the cover, 4006 in FIG. 4, 4000, between the childproof cap and the existing wall plate, consists of two right circular cylinder segments of different diameters stacked on top of each other but any connecting shape is allowable. The childproof cap, 4002, is removable and when removed, an adult may operate the toggle or rocker switch elements enclosed by the childproof cover. Additional childproof features are also included in the present invention to negate any additional attempts by children to operate the wall switch with the childproof cap removed. These features include a passage opening smaller than a child's hand and a distance from the entrance to the toggle switch longer than a child's fingers.

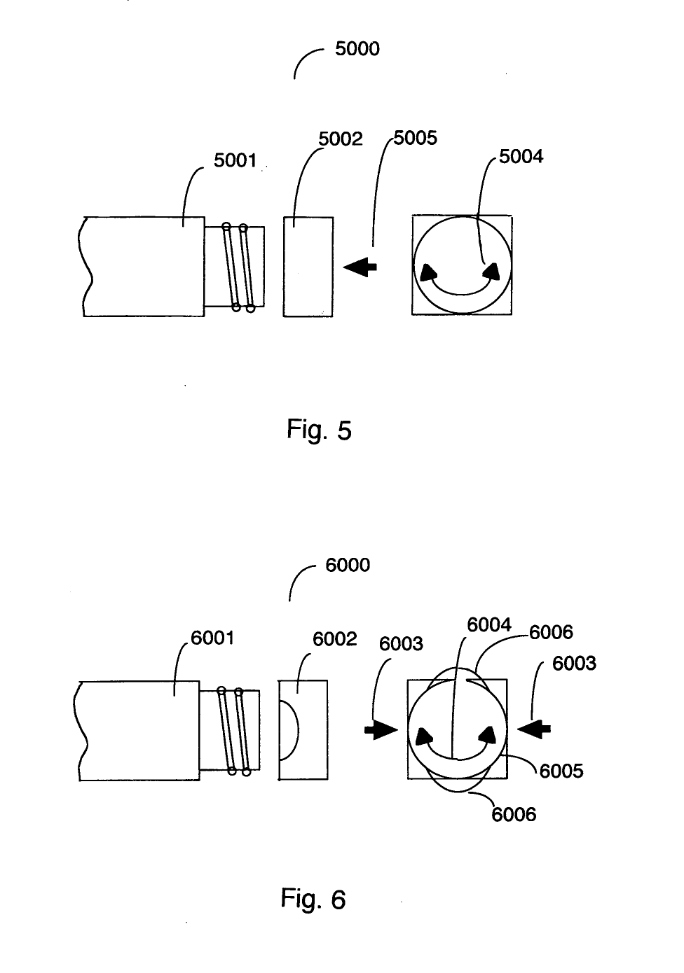

Childproof caps that exist in prior art fall into two major categories: Type 1 childproof caps that are removed by the simultaneous application of axial pressure and twisting as illustrated in FIG. 5, 5000, or Type 2 childproof caps that are removed by the simultaneous application of lateral squeezing pressure to the cap and twisting as illustrated in FIG. 6, 6000. When the elements that form a Type 1 childproof cap are assembled together, the outer portion of the cap freely rotates and can only be removed by simultaneous application of axial pressure and twisting. A Type 2 childproof cap employs an outer cap constructed from flexible material and when the elements forming that type of cap are assembled together, the outer portion of the cap is fixed in place by interfering cogs between the removable portion and the fixed base.

Side view and end view drawings of a Type 1 childproof cap are presented in FIG. 5, 5000 and illustrate the features of such a cap. The removable portion, 5002 is mounted over raised threads on the fixed base, 5001. Application of axial pressure, 5005 and twisting torque, 5004, result in the release of the removable cap for its fixed base.

Side view and end view drawings of a Type 2 childproof cap are presented in FIG. 6, 6000. The removable portion of the cap, 6002, is formed from thin flexible materials which allows its shape to be changed from its normal circular cross section, 6005, to the elongated shape, 6006, by the application of lateral forces, 6003 with simultaneous twist removing the cap: the elongated shape that is formed disengaging the previously fixed portion of the cap from the fixed base and allowing the cap's removal. The fixed base is noted as 6001.

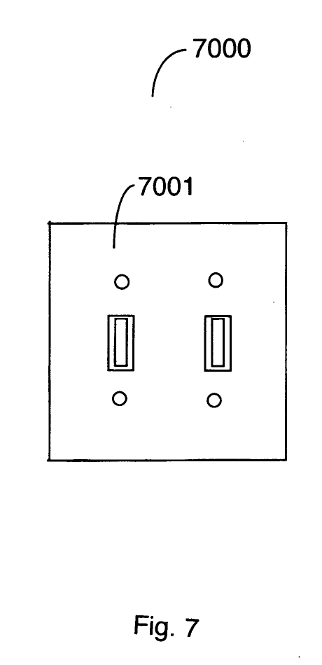

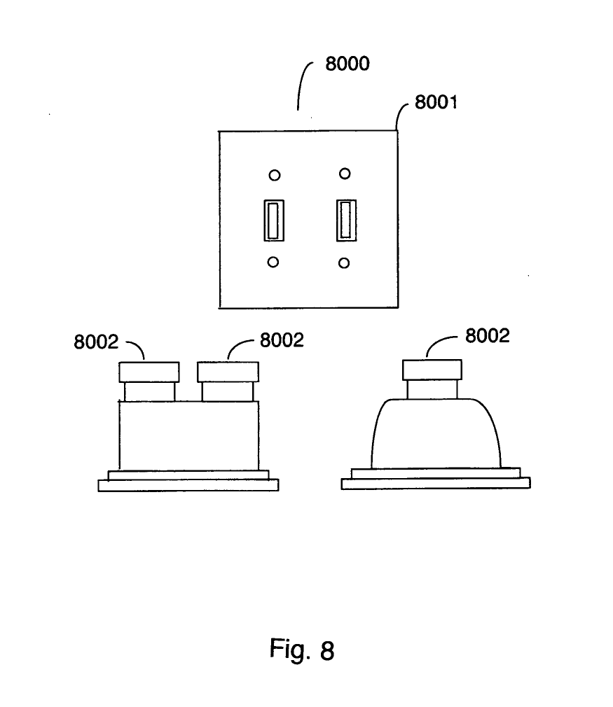

FIG. 7, 7000, is a plan view drawing of a prior art two toggle electrical switch, 7001, and FIG. 8, 8000, illustrates how the preferred embodiment for the childproof cap of the present invention is applied to a dual toggle switch unit, 8001. The childproof cover for the electrical switch employing dual toggle switch elements is constructed by laterally expanding a single toggle switch cover to enclose both toggle switch elements and adding separate childproof caps, 8002, over each of the dual toggle switch elements. The top view shown on the bottom left and the side view shown on the bottom right. Again, the dual toggle switch cover of the present invention is held in place on top of the existing dual toggle switch by threaded machine screws mounted in the existing switch box receptors to achieve a rugged connection of the childproof electrical switch cover with the wall. The approach illustrated in FIG. 8, 8000, may also be expanded further in the lateral direction (not shown) to form a childproof cover for electrical switches employing three of more toggle elements combined on a single switch plate.

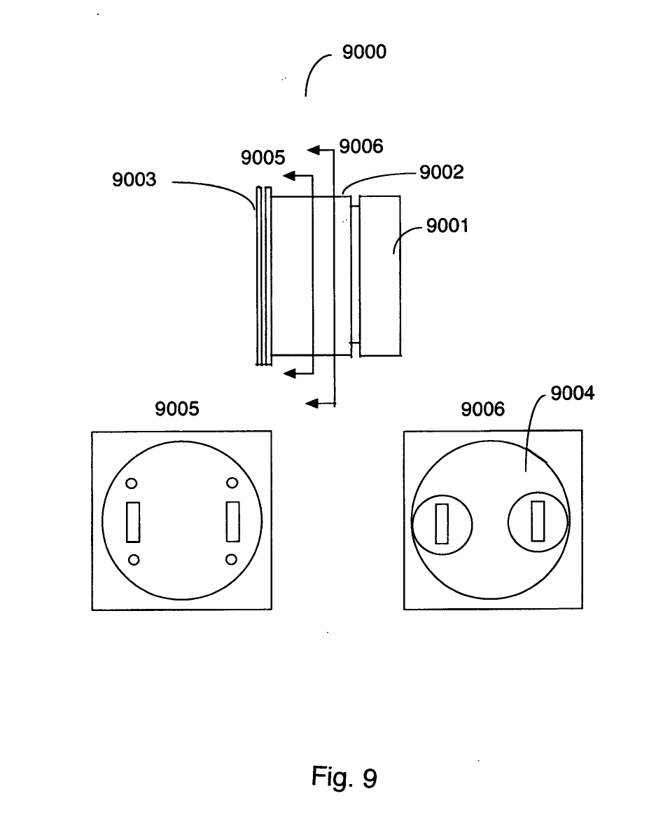

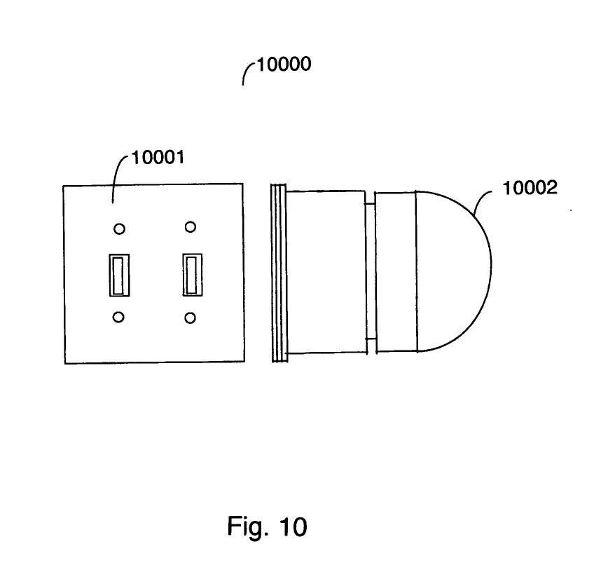

FIG. 9, 9000 and FIG. 10, 10000 present alternative childproof cover designs for dual toggle or dual rocker switch element electrical switches. In FIG. 9, 9000, a large diameter, removable cap of circular form and shallow height, 9001, is attached to a fixed circular base, 9002, which itself is attached to the original wall switch, 9003: the two parts forming the childproof cover that is fashioned over the dual toggle or dual rocker switch elements of the dual control element wall switch. The wide breadth of the flat cover requiring a harder, coordinated, two hand effort by the child to even attempt to remove the childproof caps. Secondary childproofing is supplied by a flat plate, 9004, located just within the opening that is exposed if the flat cap was removed. The flat plate, 9004, is equipped with two openings thru which the toggle or rocker switch elements may be operated by an adult but not by a child. FIG. 9, 9000, also presents cross-sectional View 9005 and cross sectional View 9006 which illustrate what can be seen inside the childproof electric switch cover at two different heights above the existing electric switch: View 9005 closer to the switch, 9003, than View 9006.

In FIG. 10, 10000, an alternative design for the childproof cover of the present invention for a dual toggle 10001 or dual rocker (not shown) switch is presented which incorporates a removeable cap, 10002, in the form of a domed structure shown in side view: the large diameter of the domed cap, again requiring a coordinated, two hand effort by the child to even attempt to remove the childproof caps and in addition the smooth, curved shape of the large dome eliminating any potential handgrips that a child might find and use to gain traction with the dome in an attempt to remove it. With the domed cap removed, childproof features are preserved by a flat plate located just within the opening: the flat plate itself equipped with two smaller openings that are smaller then a child's hand and with the plate located at a distance from the switch element that is longer than a child's finger.

Although the present invention has been described with reference to preferred embodiments, those skilled in the art will recognize that changes may be made in form and detail without departing from the spirit and scope of the invention. As such, it is intended that the foregoing detailed description be regarded as illustrative rather than limiting and that it is the appended claims, including all equivalents thereof, which are intended to define the scope of the invention.

I claim:

1. A childproof electric switch cover for single and multiple toggle element and single and multiple rocker switch element electrical switches comprising a childproof cover that is placed over and against the existing electrical switch and cinched in place using the same hardware that originally held the existing switch rigidly in place: the existing switch now situated in a protected volume from children access formed between the original switch and the added childproof cover.

2. A childproof electric switch cover that allows the electrical switch to be operated by adults but prevents children from operating it with the childproof electric switch cover equipped with childproof caps that can be removed by adults but not by children and thru which adults can actuate the electrical switch elements but children can not with the childproof electric switch cover designed to remain childproof when a childproof cap is removed.

3. The childproof electric switch cover recited in claim 2, wherein: a childproof electric switch cover is assured after removal of a childproof cap which exposes an entrance into the protected volume by making the opening that is revealed physically smaller than the width of a child's hand and at a height above the existing electrical switch such that adult fingers can reach the toggle or rocker switch elements of the existing switch and actuate them but the shorter fingers of children can not reach them.

4. A childproof electric switch cover that protects dual toggle and dual rocker switches from children's access and operation by them by placing the switches in a protected volume provided by a laterally expanded cover similar in design to that for a single electric switch but with childproof caps now situated above each switch actuator:
the dual switch cover continuing to provide protection against children attempting to actuate the dual switches by physically restricting the diameter of the opening when the childproof cap is removed and by setting the height of the opening sufficiently high above the existing switch actuators that children fingers can not reach them with the childproof electric switch cover fabricated from opaque materials that prevent the child from seeing the existing electrical switch and being attracted to it and which prevent the children from seeing how adults operate the switch when a childproof cap is removed so the child can not learn to activate it themselves.

5. The childproof electric switch cover for a dual actuator switch with dual removable childproof caps recited in claim 4 wherein: the dual removable caps are replaced by a single, large diameter, flat, removable childproof cap that spans approximately the full diameter of the dual actuator switch with the increased diameter of the single removable cap making it even more difficult for a child to try to gain entry to the existing dual switches since an attempt by a child to remove the childproof cap now requires a coordinated, two handed attempt by the child since a single child's hand is too small to grasp the cover: the larger diameter removable cap having an additional flat protective shield with dual openings located just under the removable cap which prevents a child's hand or fingers from reaching the dual actuators of the existing electric switch and preserves the childproof aspects of the childproof electric switch cover with the cap removed.

6. The childproof electric switch cover for a dual actuator switch with dual removable childproof caps recited in claim 4 wherein: the dual removable caps are replaced by a single, large diameter, dome shaped removable childproof cap: the dome shape of the removable cap, its curved form and the lack of handholds on its smooth curved surface preventing a child from ever removing it.

7. The childproof electric switch cover with removable childproof caps that allow adults to actuate the existing switch but not by children recited in claim 2 wherein: the childproof caps are of the Type 1 variety requiring simultaneous application of axial pressure on the cap and twisting of it to achieve their removal or of the Type 2 variety requiring simultaneous application of squeezing pressure and twisting to achieve their removal.
